(19) United States
(12) Patent Application Publication
(10) Pub. No.: US 2026/0034861 A1
(43) Pub. Date: Feb. 5, 2026

(54) AIR-REVERSIBLE HEATING, VENTILATION, AND AIR CONDITIONING SYSTEM WITH VENTILATION

(71) Applicant: Bergstrom, Inc., Rockford, IL (US)

(72) Inventors: Brett S. HERRMANN, Rochelle, IL (US); YEVGENIY BEYGEL, Long Grove, IL (US); IAN BOYES, Mannington (GB)

(21) Appl. No.: 19/283,147

(22) Filed: Jul. 28, 2025

Related U.S. Application Data
(60) Provisional application No. 63/679,077, filed on Aug. 2, 2024.

(51) Int. Cl. B60H 1/32; B60H 1/00; F24F 11/70; F24F 13/10

(52) U.S. Cl. CPC B60H 1/3205; B60H 1/00671; F24F 11/70; F24F 13/10

(57) ABSTRACT

The various embodiments described herein include methods, devices, and systems for operating an air-reversible heating, ventilation, and air conditioning (HVAC) system in one or more operational modes. A system includes a refrigerant loop including a compressor, a first heat exchanger, an expansion device, a second heat exchanger. The system can include a chamber thermally coupled with the first and/or the second heat exchanger. The system includes a first set of ventilation doors for controlling a first amount of outdoor air and/or a first amount of return air entering (or exiting) the chamber via the second heat exchanger, and a second set of ventilation doors for controlling a second amount of outdoor air and/or a second amount of return air entering (or exiting) the chamber via the first heat exchanger. The system includes a controller for selectively controlling operation of the compressor, and the first and/or second set of ventilation doors.

### RELATED APPLICATION

This application claims priority to U.S. Provisional Application Ser. No. 63/679,077, filed Aug. 2, 2024, entitled “Air-Reversible Heating, Ventilation, And Air Conditioning System With Ventilation,” which is incorporated herein by reference.

### TECHNICAL FIELD

The following relates generally to refrigeration systems, including but not limited to, air-reversible heat pumps and air-reversible heating, ventilation, and air cooling systems for controlling temperature within a compartment.

### BACKGROUND

Heat pumps generally use complicated refrigeration circuits and occupy large physical areas. Additionally, to provide different operational modes (e.g., heating and cooling) heat pumps can require reversing valves to change the direction of refrigerant within a refrigerant loop. Existing systems can be costly and require considerable space, energy, and installation time. As such, there is a need for simpler refrigeration systems that utilize less components to effectively operate.

### SUMMARY

The systems and methods described herein are configured to provide the cooling and heating functionality of a refrigerant system without the complications of a reversible refrigerant loop. The disclosed systems and methods are able to switch between cooling, heating, and other modes by changing the direction of the airflow within a heat pump unit or other types of HVAC systems (and without a change to the direction of flow of refrigerant within the refrigerant loop). Additionally, the systems and methods disclosed herein are configured to improve air quality and user comfort without degrading system performance by controlling the amount of carbon dioxide (CO2) and humidity within the system. As described below, a sample system can include an air-reversible heat pump configured to operate ventilation doors to direct airflow and/or switch operating modes as described below.

In one aspect, a system includes a refrigerant loop, including a compressor configured to compress a gas refrigerant to a compressed refrigerant, a first heat exchanger configured to remove heat from the compressed refrigerant and convert the compressed refrigerant to a liquid refrigerant (e.g., condense the compressed refrigerant into a liquid refrigerant through cooling), an expansion device configured to remove pressure from the liquid refrigerant (e.g., lower pressure in the liquid refrigerant) such that a second heat exchanger can change a state of the liquid refrigerant, and a second heat exchanger configured to absorb heat from a chamber (or passing through the chamber) and convert the liquid refrigerant to the gas refrigerant. The system includes a chamber thermally coupled with the first heat exchanger and/or the second heat exchanger. The chamber includes a plurality of ventilation doors including a first set of ventilation doors for controlling a first amount of outdoor air and/or a first amount of return air entering a first portion of the chamber and directed toward the second heat exchanger, and a second set of ventilation doors for controlling a second amount of outdoor air and/or a second amount of return air entering a second portion of the chamber and directed toward the first heat exchanger. The system further includes a controller for selectively controlling operation of one or more of (i) the compressor, (ii) first set of ventilation doors, and/or (iii) the second set of ventilation doors. In some embodiments, the controller also selectively controls operation of one or more air-movers.

In another aspect, a method performed at an HVAC system is disclosed. The HVAC system includes a refrigerant loop thermally coupled with a chamber including one or more ventilation doors. The method includes, while the HVAC system operates in a first operational mode, adjusting a first set of ventilation doors such that a first amount of return air and/or a first amount of outdoor air enters a first portion of the chamber and is directed toward a second heat exchanger of the refrigerant loop, and adjusting a second set of ventilation doors such that a second amount of return air and/or a second amount of outdoor air enters a second portion of the chamber and is directed toward a first heat exchanger of the refrigerant loop. Adjusting the first set of ventilation doors and the second set of ventilation doors causes the HVAC system to operate in a second operational mode distinct from the first mode.

In yet another aspect, a non-transitory, computer-readable storage medium including instructions executed by one or more processors of an HVAC system. The HVAC system includes a refrigeration loop thermally coupled with a chamber including one or more ventilation doors. The instructions, when executed by one or more processors of the HVAC system, cause the HVAC system to, while the HVAC system operates in a first operational mode, adjust a first set of ventilation doors such that a first amount of return air and/or a first amount of outdoor air enters a first portion of the chamber and is directed toward a second heat exchanger of the refrigerant loop, and adjust a second set of ventilation doors such that a second amount of return air and/or a second amount of outdoor air enters a second portion of the chamber and is directed toward a first heat exchanger of the refrigerant loop. Adjusting the first set of ventilation doors and the second set of ventilation doors causes the HVAC system to operate in a second operational mode distinct from the first mode.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1C illustrate block diagrams of different operating modes of an air-reversible HVAC system, in accordance with some embodiments.

FIGS. 2A and 2B illustrate block diagrams of different ventilated operating modes of an air-reversible HVAC system, in accordance with some embodiments.

FIG. 3 is a flow diagram illustrating a method of operating an air-reversible HVAC system with ventilation in one of a plurality of operating modes, in accordance with some embodiments.

FIG. 4 is a block diagram illustrating controller in accordance with some embodiments.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

As used herein, a “refrigerant” is a fluid adapted to undergo phase transitions between liquid and gas during operation of a corresponding refrigerant system. For example, the refrigerant has a liquid-to-gas transition point below a target operating temperature of the refrigerant system. In various implementations, the refrigerant can be classified according to different flammability classes, such as a class 1, class 2, class 2L, or class 3 refrigerants.

Implementations of the present disclosure are described in the context of air reversible heat pumps or HVAC systems, and in particular, heat pumps or HVAC systems that are able to switch between operational modes based on changes to a direction of airflow within the heat pumps or HVAC systems. For purposes of this disclosure, an HVAC system can include a heat pump and/or other system configured to provide at least heating and/or cooling. The disclosed HVAC systems are configured to thermally treat and/or condition compartments or enclosed spaces, such as vehicle (e.g., cars, trucks, aircraft, etc.) cabins, rooms, buildings, etc. Additionally, the disclosed HVAC systems can be configured to thermally treat electronics, such as batteries, processors, computers, etc. The HVAC systems described herein include one or more ventilation doors for controlling the amount of air introduced into and/or removed from the HVAC system to control the airflow and select an operational mode. The HVAC systems disclosed herein are able to operate in different operational modes (e.g., cooling, heating, etc.) without changing a flow direction of a refrigerant within the refrigerant loop. By maintaining a single refrigerant flow direction, the disclosed HVAC systems can forgo the use of additional components (e.g., reversing valves) and/or complicated refrigerant loops. Further, the disclosed HVAC system are further configured to improve efficiency and user comfort by controlling the humidity and the concentration of CO2 in a treated compartment or enclosed space.

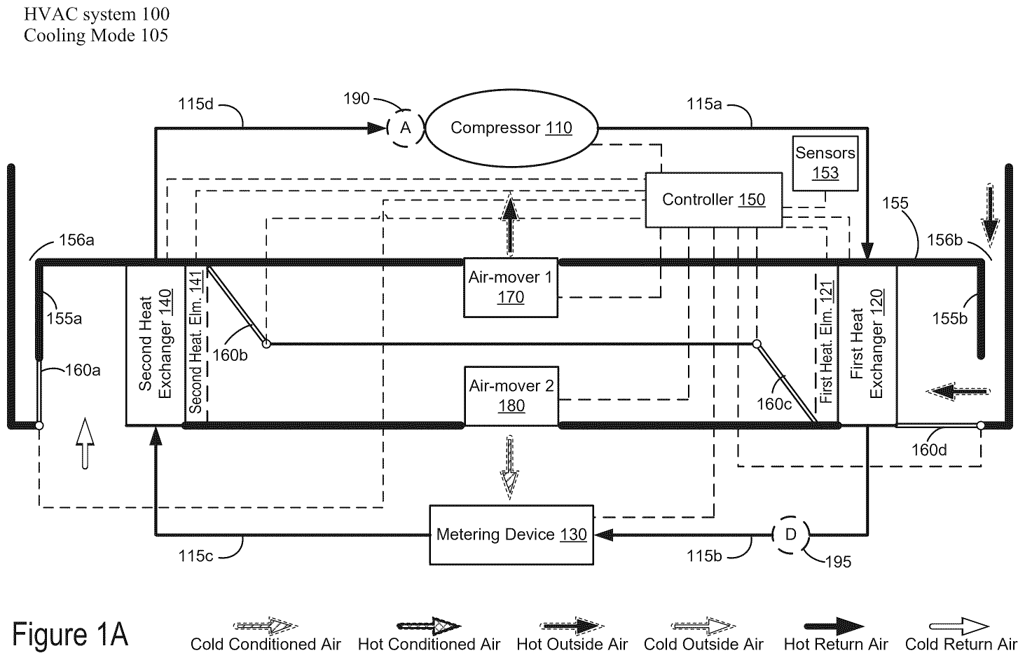

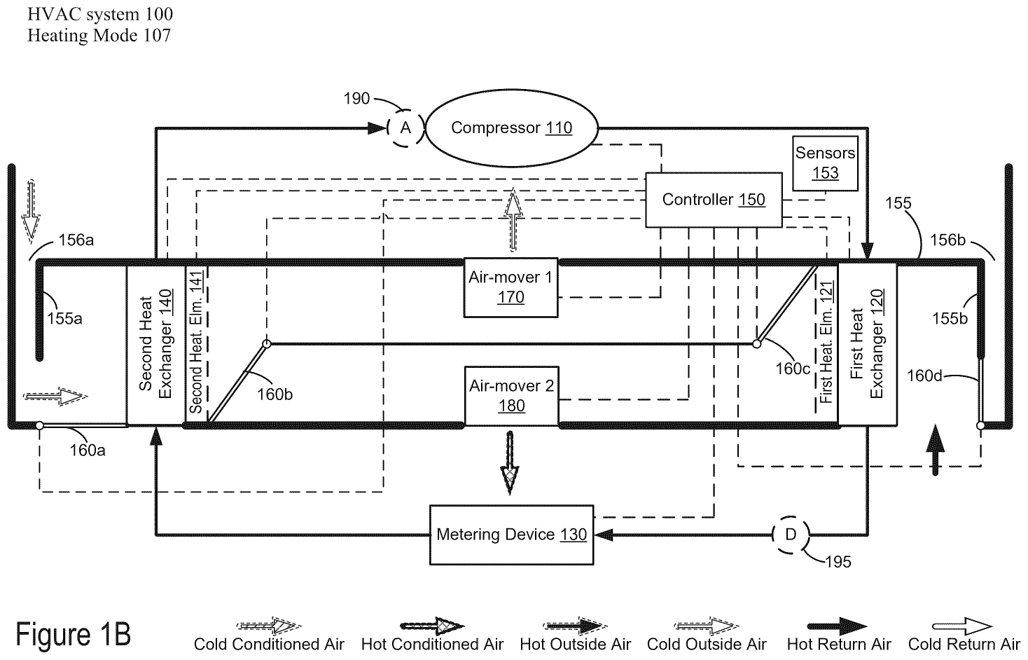

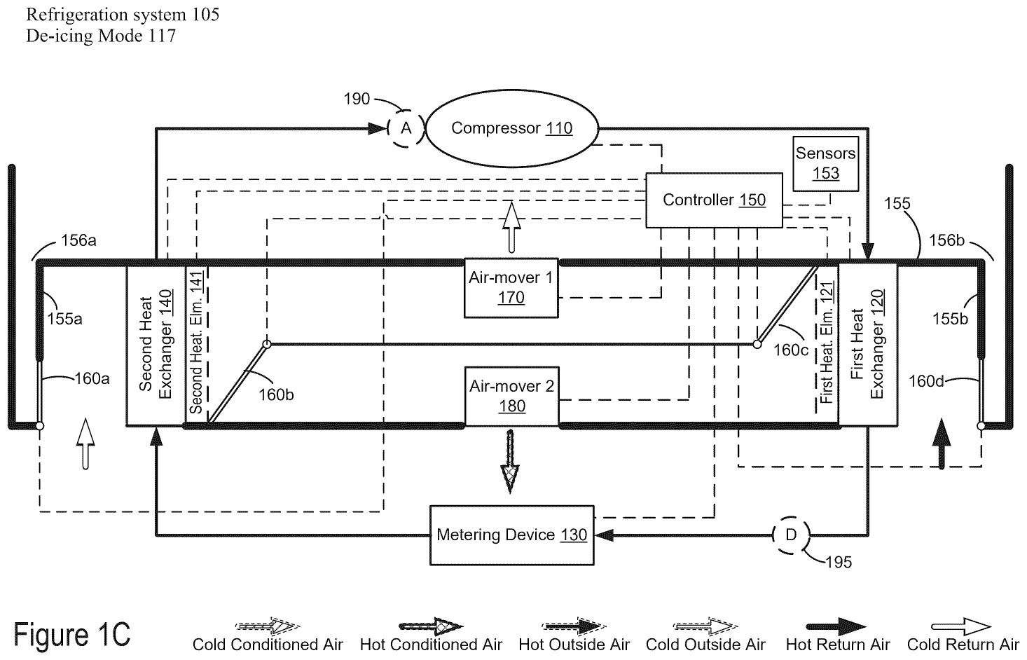

FIGS. 1A-1C illustrate block diagrams of different operating modes of an air-reversible HVAC system, in accordance with some embodiments. In particular, FIG. 1A shows the HVAC system 100 operating in a cooling mode 105, FIG. 1B shows the HVAC system 100 operating in a heating mode 107, and FIG. 1C shows the HVAC system 100 operating in a de-icing mode 117. As described below, the HVAC system 100 is configured to operate in one of a plurality of operational modes and can change between operational modes based on a change of airflow within the HVAC system 100.

The HVAC system 100 includes a refrigerant loop including of a compressor 110 (e.g., any type of compressor including but not limited to a reciprocating compressor, rotary compressor, scrolling compressor, centrifugal compressor, screw compressor, heat pump, etc.), a first heat exchanger 120 (e.g., a condenser to absorb or remove heat), a metering device 130 (e.g., an expansion device), a second heat exchanger 140 (e.g., an evaporator to absorb heat from air in a compartment). The compressor 110, the first heat exchanger 120, the metering device 130, and the second heat exchanger 140 are fluidically coupled via a plurality of refrigerant lines 115a-115d. For example, a first refrigerant line 115a fluidically couples the compressor 110 and the first heat exchanger 120; a second refrigerant line 115b fluidically couples the first heat exchanger 120 and the metering device 130; a third refrigerant line 115c fluidically couples the first heat exchanger 120 and the second heat exchanger 140; and a fourth refrigerant line 115d fluidically couples the second heat exchanger 140 and the compressor 110. In some embodiments, the refrigerant loop further includes an accumulator 190 fluidically coupled between the compressor 110 and the second heat exchanger 140, and/or a receiver drier 195 fluidically coupled between the first heat exchanger 120 and the metering device 130.

The HVAC system 100 can include a first air-mover 170 (e.g., air-mover 1, such as a fan, blower, and/or other air moving device) and/or a second air-mover 180 (e.g., air-mover 2, such as a fan, blower, and/or other air moving device) for facilitating airflow within the HVAC system 100. In some embodiments, the HVAC system 100 includes one or more heating elements (e.g., first heating element(s) 121 and second heating element(s) 141) configured to change a temperature of air passing through the one or more heating elements.

The HVAC system 100 includes a chamber 155 thermally coupled with the refrigerant loop. The HVAC system 100 is configured to condition and/or thermally treat (e.g., cool, heat, etc.) air traveling through the chamber 155. The chamber 155 includes one or more ventilation doors 160a-160d for introducing air into or removing air out of the HVAC system 100. The ventilation doors 160a-160d can include a first set of ventilation doors (e.g., a first ventilation door 160a and a second ventilation door 160b) and a second set of ventilation doors (e.g., a third ventilation door 160c and a fourth ventilation door 160d). A respective a set of ventilation doors is one or more ventilation doors associated with a heat exchanger. As discussed in detail below, the one or more ventilation doors 160a-160d are configured to control the amount of return air and/or outside (or ventilated) air within the HVAC system 100. Outside (or ventilated) can enter the HVAC system 100 via one or more ventilation channels (e.g., a first ventilation channel 156a and a second ventilation channel 156b).

The HVAC system 100 can further include one or more sensors 153 (e.g., temperature sensors, pressure sensors, CO2 sensors, thermometers, thermostats, humidity sensors, etc.). The sensors 153 can be configured to sense data from the refrigerant loop (e.g., at the compressor 110, the first heat exchanger 120, the metering device 130, the second heat exchanger 140, and/or between the components), the chamber 155, and or a compartment or enclosed space conditioned or thermally treated by the HVAC system 100. The one or more sensors are configured to sense operation data within the HVAC system 100. The operation data can include refrigerant temperature, refrigerant pressure, charge levels, second air-mover speed, first air-mover speed, compressor speeds, current or power usage, and/or other data that is used to adjust operation of the components within the HVAC system 100. Additionally, the operation data can include compartment or enclosed space data, such as a room temperature, a humidity level, CO2 levels, door position data, etc.

The HVAC system 100 further includes a controller 150 communicatively coupled with the compressor 110, the first heat exchanger 120, the metering device 130, the second heat exchanger 140, the first air-mover 170, the second air-mover 180, the sensors 153, and/or the ventilation doors 160a-160d. The controller 150 is configured to control operation of the different communicatively coupled components. In some embodiments, the controller 150 adjusts operation of one or more components based on the operational data obtained by the sensors 153 and/or operational information provided by one or more communicatively coupled components (e.g., compressor on, first air-mover on, ventilation door position, etc.). For example, the controller 150 can use the operational data to adjust a speed of the compressor 110, the first air-mover 170, and/or the second air-mover 180. Additionally, the controller 150 can be configured to identify one or more errors in the HVAC system 100 based on the operational data and/or operational information. For example, the controller 150 can calculate a compression ratio of the compressor 110 to determine whether a blockage is present and/or a location of the blockage (e.g., based on various factors such an abnormal sub-cooling level, abnormal super-cooling, etc.).

In some embodiments, the controller 150 is electrically or wirelessly coupled to an electronic device including but not limited to a display, a receiver, a smartphone or a computer. The controller 150 can provide one or more notifications or signals to be presented or used by the electronic device. For example, the notifications can include audio notifications, such as a beep, alarm, or tune, or visual notifications, such a text or graphic displayed on a screen. The signals include but are not limited to data (e.g., a cooling level, a super-heating level and a refrigerant charge level), warning signals (e.g., a refrigerant charge level is below a predetermined refrigerant charge level), maintenance request or the like. In some embodiments, the controller 150 is configured to receive one or more instructions from the electronic device for adjusting operation of the HVAC system 100. For example, the controller 150 can receive one or more instructions for adjusting a temperature of a compartment, defining a desired temperature, defining a desired temperature threshold, adjusting an air-mover speed, adjusting a compressor speed, adjusting a pump speed, etc.

The controller 150 is configured to adjust the respective positions of the ventilation doors 160a-160d. By adjusting the positions of the ventilation doors 160a-160d, the controller 150 can cause the HVAC system 100 to switch between different operational modes (e.g., cooling mode 105, heating mode 107, etc.). Specifically, the controller 150 changes the positions of the ventilation doors 160a-160d to move outside air into and/or out of the HVAC system 100, which causes a direction of the airflow within the HVAC system 100 to change and, in turn, the HVAC system 100 to operate in a different mode. By adjusting the positions of the ventilation doors 160a-160d, the HVAC system 100 is able to operate in different modes without changing a directional flow of the refrigerant. This allows the HVAC system 100 to treat and/or condition a thermally coupled compartment effectively and efficiently without requiring additional components (e.g., reverse valve) and/or a complicated refrigeration loop. In this way, the HVAC system 100 reduces costs by reducing the number of required components and complication in a system.

In some embodiments, the first set of ventilation doors can be adjusted, via the controller 150, to control a first amount of outdoor air and/or a first amount of return air entering (or exiting) a first portion 155a of the chamber 155 and directed toward the second heat exchanger 140, and the second set of ventilation doors can be adjusted, via the controller 150, to control a second amount of outdoor air and/or a second amount of return air entering (or exiting) a second portion 155b of the chamber 155 and directed toward the first heat exchanger 120. Additionally, in some embodiments, the first set of ventilation doors is configured to direct a portion of the first amount of outdoor air and/or a portion of the first amount of return air to the second air-mover 180 and/or the first air-mover 170 of the HVAC system 100, and the second set of ventilation doors is further configured to direct a portion of the second amount of outdoor air and/or a portion of the second amount of return air to the second air-mover 180 and/or the first air-mover 170 of the HVAC system 100. For example, the first ventilation door 160a can be adjusted to control the first amount of outdoor air and/or the first amount of return air entering the HVAC system 100 and the second ventilation door 160b can be adjusted to direct a portion of the first amount of outdoor air and/or a portion of the first amount of return air to the second air-mover 180 and/or the first air-mover 170 of the HVAC system 100; and the third ventilation door 160c can be adjusted to control a second amount of outdoor air and/or a second amount of return air entering the HVAC system 100 and the fourth ventilation door 160d can be adjusted to direct a portion of the second amount of outdoor air and/or a portion of the second amount of return air to the second air-mover 180 and/or the first air-mover 170 of the HVAC system 100. In this way, the HVAC system 100 controls the amount of return air and/or outdoor air that enters and/or exits the HVAC system 100.

Turning to FIG. 1A, which shows the HVAC system 100 operating in a cooling mode 105. While the HVAC system 100 is operating in the cooling mode 105, the controller 150 is configured to operate the first set of ventilation doors such that the first amount of return air entering the HVAC system 100 via the first portion 155a of the chamber 155 is a non-zero amount and the first amount of outdoor air entering the HVAC system 100 via the first portion 155a of the chamber is substantially zero (e.g., zero or minor leakage due to an non-airtight seal). Additionally, while the HVAC system 100 is operating in the cooling mode 105, the controller 150 is configured to operate the second set of ventilation doors such that the second amount of return air entering the HVAC system 100 via the second portion 155b of the chamber 155 is substantially zero and the second amount of outdoor air entering the HVAC system 100 via the second portion 155b of the chamber 155 is a non-zero amount. For example, as shown in cooling mode 105, the first ventilation door 160a is in a closed ventilation position such that cold return air enters the chamber 155 via the second heat exchanger 140, and the fourth ventilation door 160d is in an open ventilation position such that hot (or unconditioned) outside air travels through the second ventilation channel 156b and enters the chamber 155 via the first heat exchanger 120.

Similarly, while the HVAC system 100 is operating in the cooling mode 105, the controller 150 is configured to operate the first set of ventilation doors such that a portion of the first amount of return air entering the HVAC system 100 is directed to the second air-mover 180, and operate the second set of ventilation doors such that a portion of the second amount of outdoor air entering the HVAC system 100 is directed to the first air-mover 170. For example, as shown in the cooling mode 105, the second ventilation door 160b is in a closed first air-mover position (or open second air-mover position) such that a portion of the cold return air is directed to the second air-mover 180, and the third ventilation door 160c is in a closed second air-mover position (or open first air-mover position) such that a portion of the hot (or unconditioned) outside air is directed to the first air-mover 170. This allows for cold conditioned air to be moved by the second air-mover 180 into a compartment (or thermally coupled device or space) and the untreated air to be exhausted by the first air-mover 170.

In FIG. 1B, the HVAC system 100 is operating in the heating mode 107. As described above, the HVAC system 100 can use the controller 150 to adjust the positions of the ventilation doors 160a-160d to change its operational mode (e.g., from the cooling mode 105 to the heating mode 107 or the de-icing mode 117). While the HVAC system 100 is operating in the heating mode 107, the controller 150 is configured to operate the first set of ventilation doors such that the first amount of return air entering the HVAC system 100 via the first portion 155a of the chamber 155 is substantially zero and the first amount of outdoor air entering the HVAC system 100 via the first portion 155a of the chamber 155 is a non-zero amount. Additionally, while the HVAC system 100 is operating in the heating mode 107, the controller 150 is configured to operate the second set of ventilation doors such that the second amount of return air entering the HVAC system 100 via the second portion 155b of the chamber 155 is a non-zero amount and the second amount of outdoor air entering the HVAC system 100 via the second portion 155b of the chamber 155 is substantially zero. For example, as shown in the heating mode 107, the first ventilation door 160a is in an open ventilation position such that cold outside air travels through the first ventilation channel 156a and enters the chamber 155 via the second heat exchanger 140, and the fourth ventilation door 160d is in a closed ventilation position such that hot return air enters the chamber 155 enters via the first heat exchanger 120.

Similarly, while the HVAC system 100 is operating in the heating mode 107, the controller 150 is configured to operate the first set of ventilation doors such that a portion of the first amount of outside air entering the HVAC system 100 is directed to the first air-mover 170, and operate the second set of ventilation doors such that a portion of the second amount of return air entering the HVAC system 100 is directed to the second air-mover 180. For example, as shown in the heating mode 107, the second ventilation door 160b is in a closed second air-mover position (or open first air-mover position) such that a portion of the cold outside air is directed to the first air-mover 170, and the third ventilation door 160c is in a closed first air-mover position (or open second air-mover position) such that a portion of the hot return air is directed to the second air-mover 180. This allows for hot conditioned air to be moved by the second air-mover 180 into a compartment (or thermally coupled device or space) and the untreated air be exhausted by the first air-mover 170.

In FIG. 1C, the HVAC system 100 is operating in the de-icing mode 117. The HVAC system 100 can use the controller 150 to switch to the de-icing mode 117 from either the cooling mode 105 or the heating mode 107. While the HVAC system 100 is operating in the de-icing mode 117, the controller 150 is configured to operate the first set of ventilation doors such that the first amount of return air entering the HVAC system 100 via the first portion 155a of the chamber 155 is a non-zero amount and the first amount of outdoor air entering the HVAC system 100 via the first portion 155a of the chamber 155 is substantially zero. Additionally, while the HVAC system 100 is operating in the de-icing mode 117, the controller 150 is configured to operate the second set of ventilation doors such that the second amount of return air entering the HVAC system 100 via the second portion 155b of the chamber 155 is a non-zero amount and the second amount of outdoor air entering the HVAC system 100 via the second portion 155b of the chamber 155 is substantially zero. For example, as shown in the de-icing mode 117, the first ventilation door 160a is in a closed ventilation position such that cold return air enters the chamber 155 via the second heat exchanger 140, and the fourth ventilation door 160d is in a closed ventilation position such that hot return air enters the chamber 155 enters via the first heat exchanger 120.

Similarly, while the HVAC system 100 is operating in the de-icing mode 117, the controller 150 is configured to operate the first set of ventilation doors such that a portion of the first amount of return air entering the HVAC system 100 is directed to the first air-mover 170, and operate the second set of ventilation doors such that a portion of the second amount of return air entering the HVAC system 100 is directed to the second air-mover 180. For example, as shown in the de-icing mode 117, the second ventilation door 160b is in a closed second air-mover position (or open first air-mover position) such that a portion of the cold return air is directed to the first air-mover 170, and the third ventilation door 160c is in a closed first air-mover position (or open second air-mover position) such that a portion of the hot return air is directed to the second air-mover 180. This allows for hot conditioned air to be moved by the second air-mover 180 into a compartment (or thermally coupled device or space) and the untreated air be exhausted by the first air-mover 170.

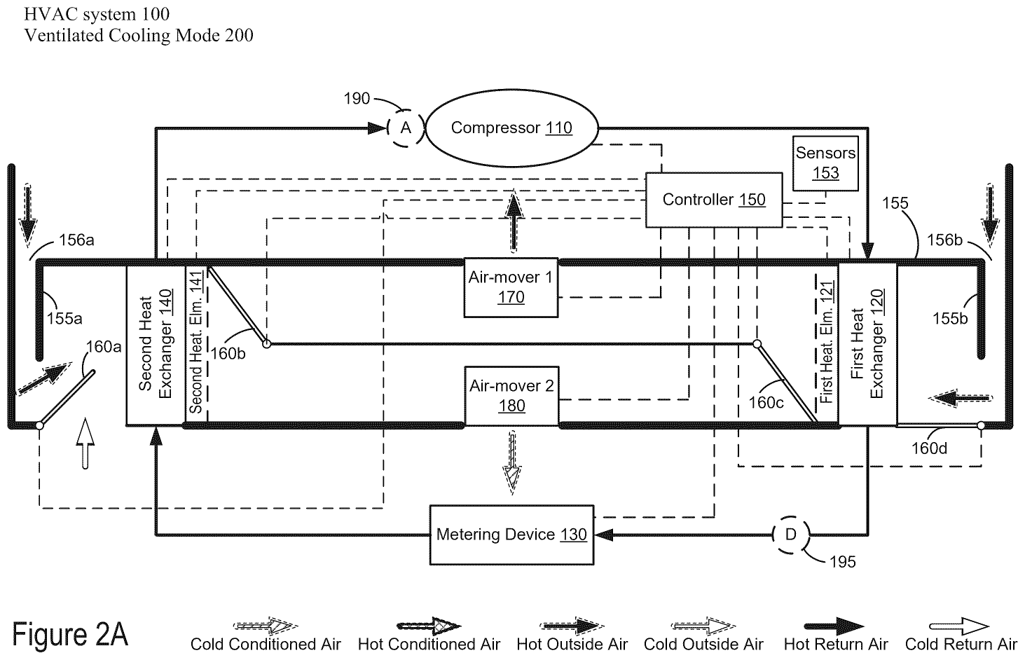

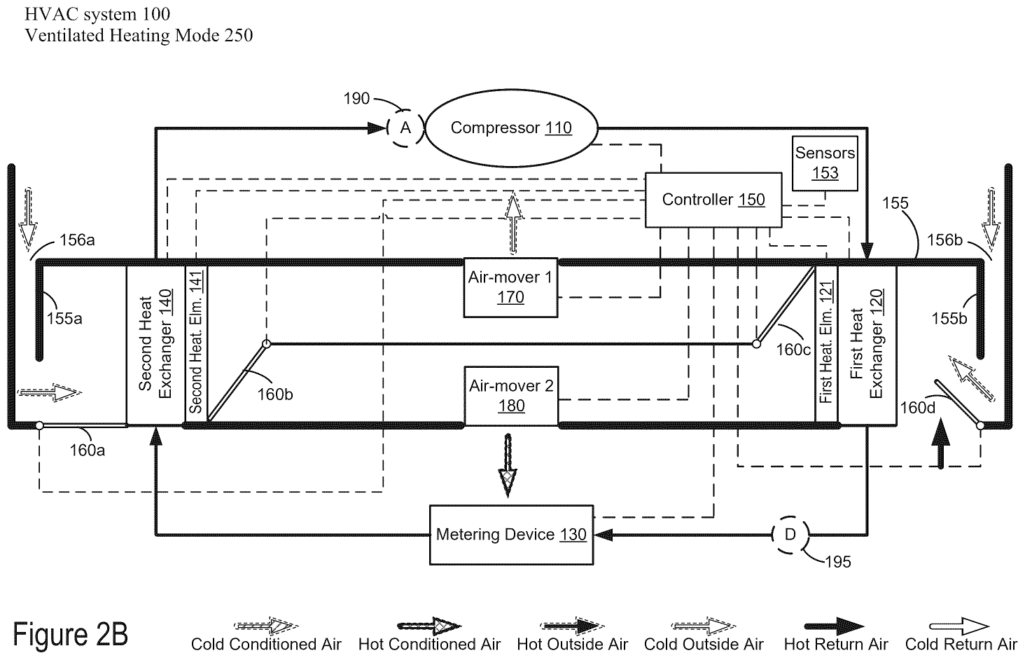

FIGS. 2A and 2B illustrate block diagrams of different ventilated operating modes of an air-reversible HVAC system, in accordance with some embodiments. In particular, FIG. 2A shows the HVAC system 100 operating in a ventilated cooling mode 200 and FIG. 2B shows the HVAC system 100 operating in a ventilated heating mode 250. The HVAC system 100 can adjust the position of the ventilation doors 160 to switch between operational modes as discussed above in reference to FIGS. 1A-IC. Similarly, the HVAC system 100 in FIGS. 2A and 2B includes a refrigerant loop as described above in reference to FIGS. 1A-1C.

In FIG. 2A, the HVAC system 100 is operating in the ventilated cooling mode 200 (e.g., cooling with outside air). While the HVAC system 100 is operating in the ventilated cooling mode 200, the controller 150 is configured to operate the first set of ventilation doors such that the first amount of return air entering the HVAC system 100 via the first portion 155a of the chamber 155 is a non-zero amount and the first amount of outdoor air entering the HVAC system 100 via the first portion 155a of the chamber 155 is a non-zero amount. Additionally, while the HVAC system 100 is operating in the ventilated cooling mode 200, the controller 150 is configured to operate the second set of ventilation doors such that the second amount of return air entering the HVAC system 100 via the second portion 155b of the chamber 155 is substantially zero and the second amount of outdoor air entering the HVAC system 100 via the second portion 155b of the chamber 155 is a non-zero amount. For example, as shown in the ventilated cooling mode 200, the first ventilation door 160a is in an intermediary ventilation position such that hot outside air travels through the first ventilation channel 156a and enters the chamber 155 via the second heat exchanger 140 and cold return air enters the chamber 155 via the second heat exchanger 140; and the fourth ventilation door 160d is in an open ventilation position such that hot outside air travels through the second ventilation channel 156b and enters the chamber 155 enters via the first heat exchanger 120.

Similarly, while the HVAC system 100 is operating in the ventilated cooling mode 200, the controller 150 is configured to operate the first set of ventilation doors such that a portion of the first amount of outside air and a portion of the first amount of return air entering the HVAC system 100 is directed to the second air-mover 180, and operate the second set of ventilation doors such that a portion of the second amount of outside air entering the HVAC system 100 is directed to the first air-mover 170. For example, as shown in the ventilated cooling mode 200, the second ventilation door 160b is in a closed first air-mover position (or open second air-mover position) such that a portion of the cold return air and a portion of the hot outside air is directed to the second air-mover 180, and the third ventilation door 160c is in a closed second air-mover position (or open first air-mover position) such that a portion of the hot outside air is directed to the first air-mover 170. This allows for a mixture of hot outside air and cold return air to be conditioned (the conditioned mixture represented by the cold conditioned air arrow in FIG. 2A) and moved by the second air-mover 180 into a compartment (or thermally coupled device or space) and the untreated air be exhausted by the first air-mover 170.

In FIG. 2B, the HVAC system 100 is operating in the ventilated heating mode 250 (e.g., heating with outside air mode). While the HVAC system 100 is operating in the ventilated heating mode 250, the controller 150 is configured to operate the first set of ventilation doors such that the first amount of return air entering the HVAC system 100 via the first portion 155a of the chamber 155 is substantially zero and the first amount of outdoor air entering the HVAC system 100 via the first portion 155a of the chamber 155 is a non-zero amount. Additionally, while the HVAC system 100 is operating in the ventilated heating mode 250, the controller 150 is configured to operate the second set of ventilation doors such that the second amount of return air entering the HVAC system 100 via the second portion 155b of the chamber 155 is a non-zero amount and the second amount of outdoor air entering the HVAC system 100 via the second portion 155b of the chamber 155 is a non-zero amount. For example, as shown in the ventilated heating mode 250, the first ventilation door 160a is in an open ventilation position such that cold outside air travels through the first ventilation channel 156a and enters the chamber 155 via the second heat exchanger 140; and the fourth ventilation door 160d is in an intermediary ventilation position such that cold outside air travels through the second ventilation channel 156b and enters via the first heat exchanger 120 and hot return air enters the chamber 155 enters via the first heat exchanger 120.

Similarly, while the HVAC system 100 is operating in the ventilated heating mode 250, the controller 150 is configured to operate the first set of ventilation doors such that a portion of the first amount of outside air entering the HVAC system 100 is directed to the first air-mover 170, and operate the second set of ventilation doors such that a portion of the second amount of outside air and a portion of the second amount of return air entering the HVAC system 100 is directed to the second air-mover 180. For example, as shown in the ventilated heating mode 250, the second ventilation door 160b is in a closed second air-mover position (or open first air-mover position) such that a portion of the cold outside air is directed to the first air-mover 170, and the third ventilation door 160c is in a closed first air-mover position (or open second air-mover position) such that a portion of the cold outside air and a portion of the hot return air is directed to the second air-mover 180. This allows for a mixture of cold outside air and hot return air to be conditioned (the conditioned mixture represented by the hot conditioned air arrow in FIG. 2b) and moved by the second air-mover 180 into a compartment (or thermally coupled device or space) and the untreated air be exhausted by the first air-mover 170.

By utilizing outside air to heat and/or cool, the HVAC system is able to control humidity and CO2 levels within a compartment (as discussed below) to improve user comfort and maintain the overall efficiency of the HVAC system 100.

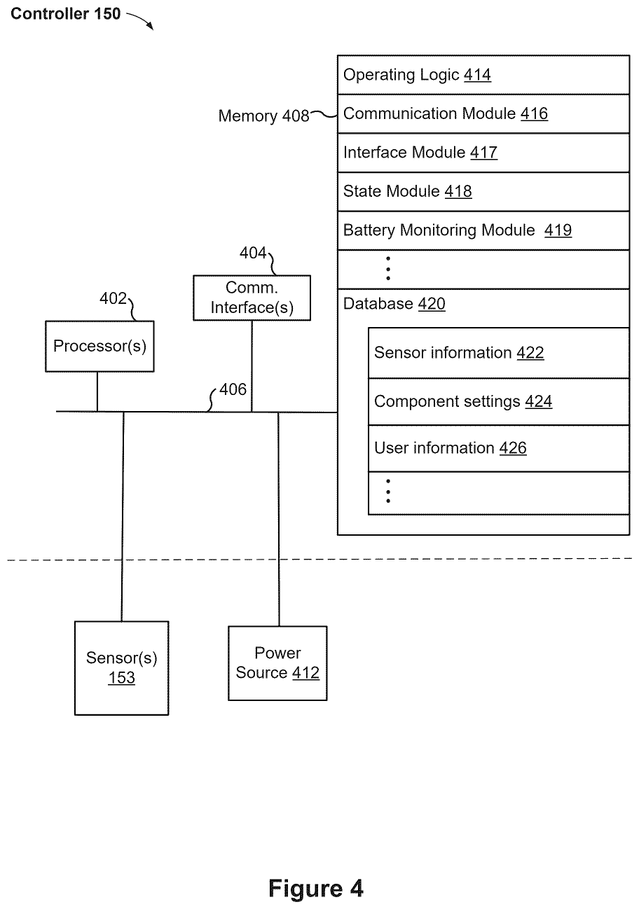

In various embodiments, the HVAC system 100 includes one or more additional components not shown in FIGS. 1A-2B, such as a user interface, air filters, refrigerant storage, and the like. In some embodiments, the HVAC system 100 includes at least one user interface (e.g., a touch screen). In some embodiments, the HVAC system 100 includes at least one battery or power source and a battery monitoring system (also sometimes called a battery management module 419, as shown and described below in reference to FIG. 4). In some embodiments, the battery monitoring module 419 is communicatively coupled at least one sensor (e.g., a current sensor). In some embodiments, the battery monitoring system 428 includes a part of a controller 150. In some embodiments, the controller 150 is electrically coupled to other components of the HVAC system 100 (described below) to control operation of these components.

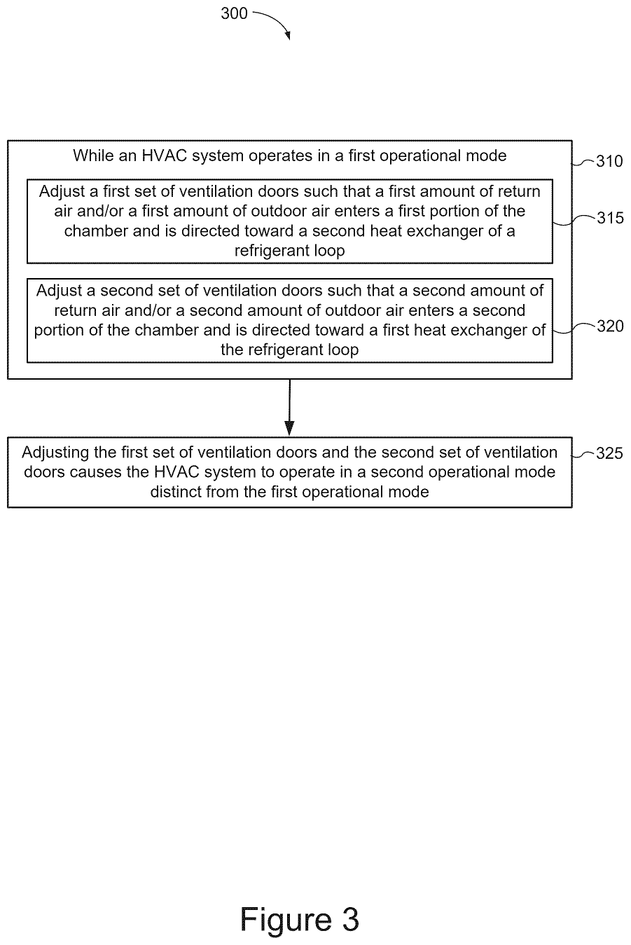

FIG. 3 is a flow diagram illustrating a method 300 of operating an air-reversible HVAC system with ventilation in one of a plurality of operating modes, in accordance with some embodiments. In some embodiments, the method 300 is performed by an HVAC system 100 (e.g., via controller 150) described above in reference to Figures IA-2B. In some implementations, the method 300 is governed by instructions that are stored in a non-transitory computer-readable storage medium (e.g., the memory 408; FIG. 4) and the instructions are executed by one or more processors of the electronic device (e.g., the processors 402 of controller 150; FIG. 4). For convenience, the method 300 is described below as being performed by HVAC system 100.

The method 300 includes, while the HVAC system 100 operates (310) in a first operational mode, adjusting (315) a first set of ventilation doors such that a first amount of return air and/or a first amount of outdoor air enters a first portion of the chamber (e.g., first portion 155a of chamber 155) and is directed toward a second heat exchanger (e.g., evaporator 140) of the refrigerant loop (e.g., of the HVAC system 100), and adjusting (320) a second set of ventilation doors such that a second amount of return air and/or a second amount of outdoor air enters a second portion of the chamber (e.g., second portion 155b of chamber 155) and is directed toward a first heat exchanger (e.g., condenser 120) of the refrigerant loop. The method 300, by adjusting the first set of ventilation doors and the second set of ventilation doors, causes (325) the HVAC system 100 to operate in a second operational mode distinct from the first operational mode. The HVAC system 100 can include a plurality of operational modes including, but not limited to, an on mode; an off mode, a cooling mode 105 (FIG. 1A), a heating mode 107 (FIG. 1B), a de-icing mode 117 (FIG. 1C), a cooling with outside air mode 200 (FIG. 2A), and a heating with outside air mode 250 (FIG. 2B).

In some embodiments, causing the HVAC system 100 to operate in a cooling mode includes adjusting the first set of ventilation doors such that the first amount of return air entering the system via the first portion of the chamber is a non-zero amount and the first amount of outdoor air entering the system via the first portion of the chamber is substantially zero, and adjusting the second set of ventilation doors such that the second amount of return air entering the system via the second portion of the chamber is substantially zero and the second amount of outdoor air entering the system via the second portion of the chamber is a non-zero amount. Additionally, causing the HVAC system 100 to operate in the cooling mode can further include adjusting the first set of ventilation doors such that a portion of the first amount of return air entering the system is directed to the second air-mover, and adjusting the second set of ventilation doors such that a portion of the second amount of outdoor air is directed to the first air-mover.

In some embodiments, causing the HVAC system 100 to operate in a heating mode includes adjusting the first set of ventilation doors such that the first amount of return air entering the system via the first portion of the chamber is substantially zero and the first amount of outdoor air entering the system via the first portion of the chamber is a non-zero amount, and adjusting the second set of ventilation doors such that the second amount of return air entering the system via the second portion of the chamber is a non-zero amount and the second amount of outdoor air entering the system via the second portion of the chamber is substantially zero. Additionally, causing the HVAC system 100 to operate in the heating mode can further include adjusting the first set of ventilation doors such that a portion of the first amount of outside air entering the system is directed to the first air-mover, and adjusting the second set of ventilation doors such that a portion of the second amount of return air is directed to the second air-mover.

In some embodiments, causing the HVAC system 100 to operate in a de-icing mode includes adjusting the first set of ventilation doors such that the first amount of return air entering the system via the first portion of the chamber is a non-zero amount and the first amount of outdoor air entering the system via the first portion of the chamber is substantially zero, and adjusting the second set of ventilation doors such that the second amount of return air entering the system via the second portion of the chamber is a non-zero amount and the second amount of outdoor air entering the system via the second portion of the chamber is substantially zero. Additionally, causing the HVAC system 100 to operate in the de-icing mode can further include adjusting the first set of ventilation doors such that a portion of the first amount of return air entering the system is directed to the first air-mover, and adjusting the second set of ventilation doors such that a portion of the second amount of return air is directed to the second air-mover.

In some embodiments, causing the HVAC system 100 to operate in a cooling with outside air mode includes adjusting the first set of ventilation doors such that the first amount of return air entering the system via the first portion of the chamber is a non-zero amount and the first amount of outdoor air entering the system via the first portion of the chamber is a non-zero amount, and adjusting the second set of ventilation doors such that the second amount of return air entering the system via the second portion of the chamber is substantially zero and the second amount of outdoor air entering the system via the second portion of the chamber is a non-zero amount. The first amount of return air and the first amount of outdoor air can be the same or distinct. For example, the first amount of return air can be greater than the first amount of outdoor air, and vice versa. Additionally, causing the HVAC system 100 to operate in the cooling with outside air mode includes adjusting the first set of ventilation doors such that a portion of the first amount of return air and a portion of the first amount of outside air entering the system is directed to the second air-mover, and adjusting the second set of ventilation doors such that a portion of the second amount of outside air is directed to the first air-mover.

In some embodiments, causing the HVAC system 100 to operate in a heating with outside air mode includes adjusting the first set of ventilation doors such that the first amount of return air entering the system via the first portion of the chamber is substantially zero and the first amount of outdoor air entering the system via the first portion of the chamber is a non-zero amount, and adjusting the second set of ventilation doors such that the second amount of return air entering the system via the second portion of the chamber is a non-zero amount and the second amount of outdoor air entering the system via the second portion of the chamber is a non-zero amount. The second amount of return air and the second amount of outdoor air can be the same or distinct. For example, the second amount of return air can be greater than the second amount of outdoor air, and vice versa. Additionally, causing the HVAC system 100 to operate in the heating with outside air mode includes adjusting the first set of ventilation doors such that a portion of the first amount of outside air entering the system is directed to the first air-mover, and adjusting the second set of ventilation doors such that a portion of the second amount of outside air and a portion of the second amount of return air is directed to the second air-mover.

In some embodiments, the HVAC system 100 includes one or more sensors 153, and the method 300 can further include receiving sensor data from the one or more sensors 153 and determining an operational mode of a plurality of operational modes based on the received sensor data. The method 300 can further cause the HVAC system 100 to operate in a determined mode by adjusting the first set of ventilation doors and the second set of ventilation doors. For example, the HVAC system 100 can be configured to condition and/or thermally treat a compartment or an enclosed space, the HVAC system 100 can be set to maintain the compartment or the enclosed space at a predefined temperature, and the HVAC system 100 can use sensor data to maintain the compartment or the enclosed space at the predetermined temperature. In particular, the HVAC system 100 can control the one or more ventilated doors, based on the sensor data, to operate in a particular operational mode in order to cool, heat, and/or otherwise thermally treat and/or condition the compartment or the enclosed space such that the compartment or the enclosed space is maintained at the predefined temperature. In some embodiments, the predefined temperature is defined by a user, building administrator, and/or anyone authorized to control the HVAC system 100.

In some embodiments, the sensor data includes a measured CO2 level, and the method 300 further includes determining whether the measured CO2 level is above a predetermined level. The method 300 includes, in accordance with a determination that the measured CO2 level is above the predetermined level (e.g., 1000 ppm), adjusting the first set of ventilation doors to increase the first amount of outdoor air entering the chamber via the first portion of the chamber, and/or adjusting the second set of ventilation doors to increase the second amount of outdoor air entering the chamber via the second portion of the chamber. In some embodiments, the HVAC system 100 is configured to maintain the CO2 levels within a predetermined CO2 threshold to provide occupants with a more comfortable experience. The predetermined CO2 threshold can be between 400 ppm and 1000 ppm of CO2. The average level of CO2 in outdoor air is approximately 400 ppm and CO2 levels above 1000 ppm have been shown to result in reduced cognitive function. Further, CO2 levels above 2000 ppm can result in further reduced cognitive function, headaches, sleepiness, nausea, and increased heart rate, as well as stagnant, stale, and stuffy air. CO2 levels above 5000 ppm can be toxic and harmful to occupants. As such, it is desirable to maintain the air within a compartment or an enclosed space treated by the HVAC system 100 to maintain CO2 levels below the predetermined level (e.g., below 900 ppm of CO2) or within the predetermined CO2 threshold.

In some embodiments, the method 300 includes presenting to the user (e.g., via a user interface or a device communicatively coupled with the HVAC system 100) an air quality of a compartment or enclosed space. For example, the user can be presented with an notification indicating that the current air quality is good, moderate, or poor. In some embodiments, a good air quality can be defined as a measured CO2 level below 900 ppm, a moderate air quality can be defined as a measured CO2 level between 900 ppm and 1200 ppm, and a poor air quality can be defined as a measured CO2 level above 1200.

In some embodiments, the CO2 level is determined based on one or more of a cabin volume and/or a number of occupants (e.g., determined by an occupant sensors). In some embodiments, the CO2 level is determined based on a predetermined system model. For example, the predetermined system model can determine the CO2 level based on the amount of time that the HVAC system has been active, the amount of return air entering or exiting the chamber 155 (or compartment), the amount of outside air entering or exiting the chamber 155 (or compartment), and/or other factors.

In some embodiments, the HVAC system 100 is configured to increase the first amount of outdoor air entering the chamber 155 and/or increase the second amount of outdoor air entering the chamber at predetermined intervals (e.g., every 5 minutes, every 10 minutes, every 30 minutes, every hour, etc.). The predetermined intervals are based on “worst” case scenarios, such as the max number of occupants in a compartment or an enclosed space, a predetermined size of the compartment or the enclosed space, etc.

In some embodiments, the sensor data includes a measured humidity level, and the method 300 further includes determining whether the measured humidity level is within a predetermined humidity range. The method 300 further includes, in accordance with a determination that the measured humidity level is not within the predetermined humidity range, adjusting the first set of ventilation doors to increase or decrease the first amount of outdoor air and/or the first amount of return air entering the chamber via the first portion of the chamber to adjust a humidity of the chamber, and/or adjusting the second set of ventilation doors to increase or decrease the second amount of outdoor air and/or the second amount of return air entering the chamber via the second portion of the chamber to adjust the humidity of the chamber. The HVAC system 100 is configured to control the humidity within a compartment or an enclosed space such that the compartment or the enclosed space remains comfortable. In some embodiments, the predetermined humidity range is between 30% and 55%. In some embodiments, the HVAC system 100 is configured to maintain a humidity of less than 60% within the compartment or the enclosed space. A comfortable humidity can vary based on the season (e.g., winter, spring, summer, and fall). Additionally, by maintaining the humidity within the predetermined humidity range, the HVAC system 100 can operate more efficiently. In particular, higher humidity levels require the HVAC system 100 to work longer to generate cool air.

In some embodiments, the method 300 operations are configured to control the amount of outside air in the HVAC system 100 to minimize the impact on system performance. For example, the HVAC system 100 can be configured to maintain a predetermined amount of outside air within the HVAC system 100 to allow for sufficient ventilation without degrading performance. In some embodiments, the predetermined amount of outside air is based on a number of factors, such as the size of a compartment or an enclosed space, the number of occupants, the type of HVAC system etc. Additionally or alternatively, as discussed above, the method 300 operations are configured to control the amount of outside air and/or flow of outside air based on a measured amount of CO2 in compartment or enclosed space to sustain desired air quality.

FIG. 4 is a block diagram illustrating controller 150 in accordance with some embodiments. In some embodiments, the controller 150 is, or includes, control circuitry for operating an HVAC system 100 (FIGS. 1A-3). In some embodiments, the controller 150 includes one or more processors 402, one or more communication interfaces 404, memory 408, and one or more communication buses 406 for interconnecting these components (sometimes called a chipset). In accordance with some embodiments, the controller 150 is coupled to one or more sensors 153 (e.g., temperature sensors, pressure sensors, current sensors, etc.) and a power source 412 (e.g., a battery or electrically-driven motor). In some embodiments, the memory 408 includes high-speed random-access memory, such as DRAM, SRAM, DDR RAM, or other random-access solid-state memory devices; and, optionally, includes non-volatile memory, such as one or more magnetic disk storage devices, one or more optical disk storage devices, one or more flash memory devices, or one or more other non-volatile solid state storage devices. The memory 408, optionally, includes one or more storage devices remotely located from the one or more processors 402. The memory 408, or alternatively the non-volatile memory within the memory 408, includes a non-transitory computer readable storage medium.

In some embodiments, the memory 408, or the non-transitory computer readable storage medium of the memory 408, stores the following programs, modules, and data structures, or a subset or superset thereof: operating logic 414 including procedures for handling various basic system services and for performing hardware dependent tasks; a communication module 416 for communicatively-connecting the controller 150 to other computing devices (e.g., vehicular control system or client device) via one or more networks (e.g., the Internet); an interface module 417 for presenting information to a user and detecting user input(s) (e.g., in conjunction with communication interface(s) 404); a state module 418 for setting and/or adjusting an operating mode or state of the conditioning system (e.g., heating mode, cooling mode, de-icing mode, etc.); a battery monitoring module 419 for distributing to and/or monitoring power of one or more components of the refrigeration system; and a database 420 storing data for use in governing operation of an HVAC system (e.g., HVAC system 100; FIGS. 1A-3). The database 420 can include but is not limited to: sensor information 422 storing information regarding one or more sensors associated with the conditioning system (e.g., temperature data, pressure data, and/or current data); component settings 424 storing information regarding one or more components of the conditioning system (e.g., operational settings, such as speed and power); and user information 426 storing information regarding user preferences, settings, history, etc.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 408, optionally, stores a subset of the modules and data structures identified above. Furthermore, the memory 408, optionally, stores additional modules and data structures not described above, such as a vehicle module for interfacing between the vehicle and the conditioning system.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art after reading this disclosure, so the ordering and groupings presented herein are not an exhaustive list of alternatives.

Having thus described system-block diagrams and then example refrigeration systems, attention will now be directed to certain example embodiments.

### EXAMPLE ASPECTS

A few example aspects will now be briefly described.
(A1) In accordance with some embodiments, an air-reversible heating, ventilation, and air conditioning (HVAC) system configured to operate in a plurality of operational modes is disclosed. The HVAC system includes a refrigerant loop including a compressor configured to compress a gas refrigerant to a compressed refrigerant; a first heat exchanger configured to condense the compressed refrigerant into a liquid refrigerant through cooling; an expansion device configured to lower pressure in the liquid refrigerant such that a second heat exchanger can change a state of the liquid refrigerant; and a second heat exchanger configured to absorb heat from a chamber and convert the liquid refrigerant to the gas refrigerant. The chamber is thermally coupled with the first heat exchanger and/or the second heat exchanger. The chamber includes a plurality of ventilation doors including a first set of ventilation doors for controlling a first amount of outdoor air and/or a first amount of return air entering a first portion of the chamber and directed toward the second heat exchanger, and a second set of ventilation doors for controlling a second amount of outdoor air and/or a second amount of return air entering a second portion of the chamber and directed toward the first heat exchanger. The HVAC system further includes a controller for selectively controlling operation of one or more of (i) the compressor, (ii) first set of ventilation doors, and/or (iii) the second set of ventilation doors.
(A2) In some embodiments of A1, the first set of ventilation doors is further configured to direct a portion of the first amount of outdoor air and/or a portion of the first amount of return air to a second air-mover or a first air-mover of the system, and the second set of ventilation doors is further configured to direct a portion of the second amount of outdoor air and/or a portion of the second amount of return air to the second air-mover or the first air-mover of the system.
(A3) In some embodiments of A2, the first set of ventilation doors includes (i) a first ventilation door configured to control the first amount of outdoor air and/or the first amount of return air entering the system via the first portion of the chamber and (ii) a second ventilation door configured to direct the portion of the first amount of outdoor air and/or the portion of the first amount of return air to the second air-mover or the first air-mover of the system; and the second set of ventilation doors includes (i) a third ventilation door configured to control the second amount of outdoor air and/or the second amount of return air entering the system via the second portion of the chamber and (ii) a fourth ventilation door configured to direct the portion of the second amount of outdoor air and/or the portion of the second amount of return air to the second air-mover or the first air-mover of the system.
(A4) In some embodiments of any of A1-A3, the system is configured to operate in one of a plurality of operational modes and the controller is further configured to change an operational mode of the system via operation of the first set of ventilation doors and/or the second set of ventilation doors.
(A5) In some embodiments of A4, operating the system in a first operational mode of the plurality of operational modes includes operating, via the controller, the first set of ventilation doors such that the first amount of return air entering the system via the first portion of the chamber is a non-zero amount and the first amount of outdoor air entering the system via the first portion of the chamber is substantially zero; and operating, via the controller, the second set of ventilation doors such that the second amount of return air entering the system via the second portion of the chamber is substantially zero and the second amount of outdoor air entering the system via the second portion of the chamber is a non-zero amount.
(A6) In some embodiments of A5, operating the system in the first operational mode of the plurality of operational modes includes operating, via the controller, the first set of ventilation doors such that a portion of the first amount of return air entering the system is directed to the second air-mover; and operating, via the controller, the second set of ventilation doors such that a portion of the second amount of outdoor air is directed to the first air-mover.
(A7) In some embodiments of any of A4-A6, operating the system in a second operational mode of the plurality of operational modes includes operating, via the controller, the first set of ventilation doors such that the first amount of return air entering the system via the first portion of the chamber is substantially zero and the first amount of outdoor air entering the system via the first portion of the chamber is a non-zero amount; and operating, via the controller, the second set of ventilation doors such that the second amount of return air entering the system via the second portion of the chamber is a non-zero amount and the second amount of outdoor air entering the system via the second portion of the chamber is substantially zero.
(A8) In some embodiments of A7, operating the system in the second operational mode of the plurality of operational modes includes operating, via the controller, the first set of ventilation doors such that a portion of the first amount of outside air entering the system is directed to the first air-mover; and operating, via the controller, the second set of ventilation doors such that a portion of the second amount of return air is directed to the second air-mover.
(A9) In some embodiments of any of A4-A8, operating the system in a third operational mode of the plurality of operational modes includes operating, via the controller, the first set of ventilation doors such that the first amount of return air entering the system via the first portion of the chamber is a non-zero amount and the first amount of outdoor air entering the system via the first portion of the chamber is substantially zero; and operating, via the controller, the second set of ventilation doors such that the second amount of return air entering the system via the second portion of the chamber is a non-zero amount and the second amount of outdoor air entering the system via the second portion of the chamber is substantially zero.
(A10) In some embodiments of A9, operating the system in the third operational mode of the plurality of operational modes includes operating, via the controller, the first set of ventilation doors such that a portion of the first amount of return air entering the system is directed to the first air-mover; and operating, via the controller, the second set of ventilation doors such that a portion of the second amount of return air is directed to the second air-mover.
(A11) In some embodiments of any of A4-A10, operating the system in a fourth operational mode of the plurality of operational modes includes operating, via the controller, the first set of ventilation doors such that the first amount of return air entering the system via the first portion of the chamber is a non-zero amount and the first amount of outdoor air entering the system via the first portion of the chamber is a non-zero amount; and operating, via the controller, the second set of ventilation doors such that the second amount of return air entering the system via the second portion of the chamber is substantially zero and the second amount of outdoor air entering the system via the second portion of the chamber is a non-zero amount.
(A12) In some embodiments of A11, operating the system in the fourth operational mode of the plurality of operational modes includes operating, via the controller, the first set of ventilation doors such that a portion of the first amount of return air and a portion of the first amount of outside air entering the system is directed to the second air-mover; and operating, via the controller, the second set of ventilation doors such that a portion of the second amount of outside air is directed to the first air-mover.
(A13) In some embodiments of any of A4-A12, operating the system in a fifth operational mode of the plurality of operational modes includes operating, via the controller, the first set of ventilation doors such that the first amount of return air entering the system via the first portion of the chamber is substantially zero and the first amount of outdoor air entering the system via the first portion of the chamber is a non-zero amount; and operating, via the controller, the second set of ventilation doors such that the second amount of return air entering the system via the second portion of the chamber is a non-zero amount and the second amount of outdoor air entering the system via the second portion of the chamber is a non-zero amount.
(A14) In some embodiments of A13, operating the system in the fifth operational mode of the plurality of operational modes includes operating, via the controller, the first set of ventilation doors such that a portion of the first amount of outside air entering the system is directed to the first air-mover; and operating, via the controller, the second set of ventilation doors such that a portion of the second amount of outside air and a portion of the second amount of return air is directed to the second air-mover.
(A15) In some embodiments of any of A4-A14, the controller changes an operational mode of the system without the use of a reversing valve.
(A16) In some embodiments of any of A1-A15, the HVAC system further includes one or more sensors and the controller is further configured to receive sensor data from the one or more sensors, determine an operational mode of a plurality of operational modes based on the received sensor data, and cause the system to operate in a determined mode by controlling the first set of ventilation doors and the second set of ventilation doors.
(A17) In some embodiments of A16, the sensor data includes a measured CO2 level and the controller is further configured to determine whether the measured CO2 level is above a predetermined level. The controller, in accordance with a determination that the measured CO2 level is above the predetermined level, is configured to control the first set of ventilation doors to increase the first amount of outdoor air entering the chamber via the first portion of the chamber, and/or control the second set of ventilation doors to increase the second amount of outdoor air entering the chamber via the second portion of the chamber.
(A18) In some embodiments of any of A16-A17, the sensor data includes a measured humidity level and the controller is further configured to determine whether the measured humidity level is within a predetermined humidity range, and in accordance with a determination that the measured humidity level is not within the predetermined humidity range, (i) control the first set of ventilation doors to increase or decrease the first amount of outdoor air and/or the first amount of return air entering the chamber via the first portion of the chamber to adjust a humidity of the chamber, and/or (ii) control the second set of ventilation doors to increase or decrease the second amount of outdoor air and/or the second amount of return air entering the chamber via the second portion of the chamber to adjust the humidity of the chamber.
(B1) In accordance with some embodiments, a method performed at an air-reversible HVAC system is disclosed. The HVAC system includes a refrigerant loop thermally coupled with a chamber including one or more ventilation doors. The method includes, while the HVAC system operates in a first operational mode, adjusting a first set of ventilation doors such that a first amount of return air and/or a first amount of outdoor air enters a first portion of the chamber and is directed toward a second heat exchanger of the refrigerant loop, and adjusting a second set of ventilation doors such that a second amount of return air and/or a second amount of outdoor air enters a second portion of the chamber and is directed toward a first heat exchanger of the refrigerant loop. Adjusting the first set of ventilation doors and the second set of ventilation doors causes the HVAC system to operate in a second operational mode distinct from the first mode
(B2) In some embodiments of B1, adjusting the first set of ventilation doors includes controlling the first set of ventilation doors such that the first amount of return air entering the system via the first portion of the chamber is a non-zero amount and the first amount of outdoor air entering the system via the first portion of the chamber is substantially zero, and adjusting the second set of ventilation doors includes controlling the second set of ventilation doors such that the second amount of return air entering the system via the second portion of the chamber is substantially zero and the second amount of outdoor air entering the system via the second portion of the chamber is a non-zero amount.
(B3) In some embodiments of B2, adjusting the first set of ventilation doors includes controlling the first set of ventilation doors such that a portion of the first amount of return air entering the system is directed to the second air-mover, and adjusting the second set of ventilation doors includes controlling second set of ventilation doors such that a portion of the second amount of outdoor air is directed to the first air-mover.
(B4) In some embodiments of any of B1-B3, adjusting the first set of ventilation doors includes controlling the first set of ventilation doors such that the first amount of return air entering the system via the first portion of the chamber is substantially zero and the first amount of outdoor air entering the system via the first portion of the chamber is a non-zero amount, and adjusting the second set of ventilation doors includes controlling the second set of ventilation doors such that the second amount of return air entering the system via the second portion of the chamber is a non-zero amount and the second amount of outdoor air entering the system via the second portion of the chamber is substantially zero.
(B5) In some embodiments of B4, adjusting the first set of ventilation doors includes controlling the first set of ventilation doors such that a portion of the first amount of outside air entering the system is directed to the first air-mover, and adjusting the second set of ventilation doors includes controlling the second set of ventilation doors such that a portion of the second amount of return air is directed to the second air-mover.
(B6) In some embodiments of any of B1-B5, adjusting the first set of ventilation doors includes controlling the first set of ventilation doors such that the first amount of return air entering the system via the first portion of the chamber is a non-zero amount and the first amount of outdoor air entering the system via the first portion of the chamber is substantially zero, and adjusting the second set of ventilation doors includes controlling the second set of ventilation doors such that the second amount of return air entering the system via the second portion of the chamber is a non-zero amount and the second amount of outdoor air entering the system via the second portion of the chamber is substantially zero.
(B7) In some embodiments of B6, adjusting the first set of ventilation doors includes controlling the first set of ventilation doors such that a portion of the first amount of return air entering the system is directed to the first air-mover, and adjusting the second set of ventilation doors includes controlling the second set of ventilation doors such that a portion of the second amount of return air is directed to the second air-mover.
(B8) In some embodiments of any of B1-B7, adjusting the first set of ventilation doors includes controlling the first set of ventilation doors such that the first amount of return air entering the system via the first portion of the chamber is a non-zero amount and the first amount of outdoor air entering the system via the first portion of the chamber is a non-zero amount, and adjusting the second set of ventilation doors includes controlling the second set of ventilation doors such that the second amount of return air entering the system via the second portion of the chamber is substantially zero and the second amount of outdoor air entering the system via the second portion of the chamber is a non-zero amount.
(B9) In some embodiments of B8, adjusting the first set of ventilation doors includes controlling the first set of ventilation doors such that a portion of the first amount of return air and a portion of the first amount of outside air entering the system is directed to the second air-mover, and adjusting the second set of ventilation doors includes controlling the second set of ventilation doors such that a portion of the second amount of outside air is directed to the first air-mover.
(B10) In some embodiments of any of B1-B9, adjusting the first set of ventilation doors includes controlling the first set of ventilation doors such that the first amount of return air entering the system via the first portion of the chamber is substantially zero and the first amount of outdoor air entering the system via the first portion of the chamber is a non-zero amount, and adjusting the second set of ventilation doors includes controlling the second set of ventilation doors such that the second amount of return air entering the system via the second portion of the chamber is a non-zero amount and the second amount of outdoor air entering the system via the second portion of the chamber is a non-zero amount.
(B11) In some embodiments of B10, adjusting the first set of ventilation doors includes controlling the first set of ventilation doors such that a portion of the first amount of outside air entering the system is directed to the first air-mover, and adjusting the second set of ventilation doors includes controlling the second set of ventilation doors such that a portion of the second amount of outside air and a portion of the second amount of return air is directed to the second air-mover adjusting the second set of ventilation doors includes controlling the second set of ventilation doors such that a portion of the second amount of outside air and a portion of the second amount of return air is directed to the second air-mover.
(B12) In some embodiments of any of B1-B11, the HVAC system further includes one or more sensors. The method further includes receiving sensor data from the one or more sensors, receiving sensor data from the one or more sensors, and causing the HVAC system to operate in a determined mode by controlling the first set of ventilation doors and the second set of ventilation doors.
(B13) In some embodiments of B12, the sensor data includes a measured CO2 level. The method further includes determining whether the measured CO2 level is above a predetermined level, and in accordance with a determination that the measured CO2 level is above the predetermined level (i) adjusting the first set of ventilation doors to increase the first amount of outdoor air entering the chamber via the first portion of the chamber, and/or (ii) adjusting the second set of ventilation doors to increase the second amount of outdoor air entering the chamber via the second portion of the chamber.
(B14) In some embodiments of any of B12-B13, the sensor data includes a measured humidity level. The method further includes determining whether the measured humidity level is within a predetermined humidity range, and in accordance with a determination that the measured humidity level is not within the predetermined humidity range (i) adjusting the first set of ventilation doors to increase or decrease the first amount of outdoor air and/or the first amount of return air entering the chamber via the first portion of the chamber to adjust a humidity of the chamber, and/or (ii) adjusting the second set of ventilation doors to increase or decrease the second amount of outdoor air and/or the second amount of return air entering the chamber via the second portion of the chamber to adjust the humidity of the chamber.
(C1) In accordance with some embodiments, a non-transitory, computer-readable storage medium including instructions performed by one or more processors of an air-reversible HVAC system is disclosed. The HVAC system includes a refrigerant loop thermally coupled with a chamber including one or more ventilation doors. The instructions, when performed by the one or more processors of the HVAC system, cause the HVAC system to, while the HVAC system operates in a first operational mode, adjust a first set of ventilation doors such that a first amount of return air and/or a first amount of outdoor air enters a first portion of the chamber and is directed toward a second heat exchanger of a refrigerant loop, and adjust a second set of ventilation doors such that a second amount of return air and/or a second amount of outdoor air enters a second portion of the chamber and is directed toward a first heat exchanger of the refrigerant loop. Adjusting the first set of ventilation doors and the second set of ventilation doors causes the HVAC system to operate in a second operational mode distinct from the first mode
(C2) In some embodiments of C1, the non-transitory, computer-readable storage medium includes further instructions that, when executed by one or more processors of the HVAC system, cause the HVAC system to perform the method of any of B2-B14.

It will also be understood that, although the terms first, second, etc. are, in some instances, used herein to describe various elements, these elements should not be limited by these terms. These terms are only used to distinguish one element from another. For example, a first valve could be termed a second valve, and, similarly, a second valve could be termed a first valve, without departing from the scope of the various described embodiments. The first valve and the second valve are both valves, but they are not the same valve unless explicitly stated.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A system, comprising:
a refrigerant loop, comprising:
a compressor configured to compress a gas refrigerant to a compressed refrigerant,
a first heat exchanger configured to condense the compressed refrigerant into a liquid refrigerant through cooling,
an expansion device configured to lower pressure in the liquid refrigerant such that a second heat exchanger can change a state of the liquid refrigerant, and
a second heat exchanger configured to absorb heat from a chamber and convert the liquid refrigerant to the gas refrigerant;
the chamber thermally coupled with the first heat exchanger and the second heat exchanger, the chamber comprising a plurality of ventilation doors including:
a first set of ventilation doors for controlling a first amount of outdoor air and/or a first amount of return air entering a first portion of the chamber and directed toward the second heat exchanger, and
a second set of ventilation doors for controlling a second amount of outdoor air and/or a second amount of return air entering a second portion of the chamber and directed toward the first heat exchanger; and
a controller for selectively controlling operation of one or more of (i) the compressor, (ii) first set of ventilation doors, and/or (iii) the second set of ventilation doors.

2. The system of claim 1, wherein:
the first set of ventilation doors is further configured to direct a portion of the first amount of outdoor air and/or a portion of the first amount of return air to a second air-mover or a first air-mover of the system, and
the second set of ventilation doors is further configured to direct a portion of the second amount of outdoor air and/or a portion of the second amount of return air to the second air-mover or the first air-mover of the system.

3. The system of claim 2, wherein:
the first set of ventilation doors includes (i) a first ventilation door configured to control the first amount of outdoor air and/or the first amount of return air entering the system via the first portion of the chamber and (ii) a second ventilation door configured to direct the portion of the first amount of outdoor air and/or the portion of the first amount of return air to the second air-mover or the first air-mover of the system; and
the second set of ventilation doors includes (i) a third ventilation door configured to control the second amount of outdoor air and/or the second amount of return air entering the system via the second portion of the chamber and (ii) a fourth ventilation door configured to direct the portion of the second amount of outdoor air and/or the portion of the second amount of return air to the second air-mover or the first air-mover of the system.

4. The system of claim 1, wherein the system is configured to operate in one of a plurality of operational modes and the controller is further configured to change an operational mode of the system via operation of the first set of ventilation doors and/or the second set of ventilation doors.

5. The system of claim 4, wherein operating the system in a first operational mode of the plurality of operational modes includes:
operating, via the controller, the first set of ventilation doors such that the first amount of return air entering the system via the first portion of the chamber is a non-zero amount and the first amount of outdoor air entering the system via the first portion of the chamber is substantially zero; and
operating, via the controller, the second set of ventilation doors such that the second amount of return air entering the system via the second portion of the chamber is substantially zero and the second amount of outdoor air entering the system via the second portion of the chamber is a non-zero amount.

6. The system of claim 5, wherein operating the system in the first operational mode of the plurality of operational modes includes:
operating, via the controller, the first set of ventilation doors such that a portion of the first amount of return air entering the system is directed to a second air-mover; and
operating, via the controller, the second set of ventilation doors such that a portion of the second amount of outdoor air is directed to a first air-mover.

7. The system of claim 4, wherein operating the system in a second operational mode of the plurality of operational modes includes:
operating, via the controller, the first set of ventilation doors such that the first amount of return air entering the system via the first portion of the chamber is substantially zero and the first amount of outdoor air entering the system via the first portion of the chamber is a non-zero amount; and
operating, via the controller, the second set of ventilation doors such that the second amount of return air entering the system via the second portion of the chamber is a non-zero amount and the second amount of outdoor air entering the system via the second portion of the chamber is substantially zero.

8. A method, comprising:
at an HVAC system comprising a refrigerant loop thermally coupled with a chamber including one or more ventilation doors:
while the HVAC system operates in a first operational mode:
adjusting a first set of ventilation doors such that a first amount of return air and/or a first amount of outdoor air enters a first portion of the chamber and is directed toward a second heat exchanger of the refrigerant loop, and
adjusting a second set of ventilation doors such that a second amount of return air and/or a second amount of outdoor air enters a second portion of the chamber and is directed toward a first heat exchanger of the refrigerant loop; and
wherein adjusting the first set of ventilation doors and the second set of ventilation doors causes the HVAC system to operate in a second operational mode distinct from the first mode.

9. The method of claim 8, wherein:
adjusting the first set of ventilation doors includes controlling the first set of ventilation doors such that the first amount of return air entering the system via the first portion of the chamber is a non-zero amount and the first amount of outdoor air entering the system via the first portion of the chamber is substantially zero; and
adjusting the second set of ventilation doors includes controlling the second set of ventilation doors such that the second amount of return air entering the system via the second portion of the chamber is substantially zero and the second amount of outdoor air entering the system via the second portion of the chamber is a non-zero amount.

10. The method of claim 9, wherein:
adjusting the first set of ventilation doors includes controlling the first set of ventilation doors such that a portion of the first amount of return air entering the system is directed to a second air-mover; and
adjusting the second set of ventilation doors includes controlling second set of ventilation doors such that a portion of the second amount of outdoor air is directed to a first air-mover.

11. The method of claim 8, wherein:
adjusting the first set of ventilation doors includes controlling the first set of ventilation doors such that the first amount of return air entering the system via the first portion of the chamber is substantially zero and the first amount of outdoor air entering the system via the first portion of the chamber is a non-zero amount; and
adjusting the second set of ventilation doors includes controlling the second set of ventilation doors such that the second amount of return air entering the system via the second portion of the chamber is a non-zero amount and the second amount of outdoor air entering the system via the second portion of the chamber is substantially zero.

12. The method of claim 11, wherein:
adjusting the first set of ventilation doors includes controlling the first set of ventilation doors such that a portion of the first amount of outside air entering the system is directed to a first air-mover; and
adjusting the second set of ventilation doors includes controlling the second set of ventilation doors such that a portion of the second amount of return air is directed to a second air-mover.

13. The method of claim 8, wherein:
adjusting the first set of ventilation doors includes controlling the first set of ventilation doors such that the first amount of return air entering the system via the first portion of the chamber is a non-zero amount and the first amount of outdoor air entering the system via the first portion of the chamber is substantially zero; and
adjusting the second set of ventilation doors includes controlling the second set of ventilation doors such that the second amount of return air entering the system via the second portion of the chamber is a non-zero amount and the second amount of outdoor air entering the system via the second portion of the chamber is substantially zero.

14. The method of claim 13, wherein:
adjusting the first set of ventilation doors includes controlling the first set of ventilation doors such that a portion of the first amount of return air entering the system is directed to a first air-mover; and
adjusting the second set of ventilation doors includes controlling the second set of ventilation doors such that a portion of the second amount of return air is directed to a second air-mover.

15. A non-transitory, computer-readable storage medium including instructions that, when executed by one or more processors of an HVAC system comprising a refrigeration loop thermally coupled with a chamber including one or more ventilation doors, cause the HVAC system to:
while an HVAC system operates in a first operational mode:
adjust a first set of ventilation doors such that a first amount of return air and/or a first amount of outdoor air enters a first portion of the chamber and is directed toward a second heat exchanger of a refrigerant loop, and
adjust a second set of ventilation doors such that a second amount of return air and/or a second amount of outdoor air enters a second portion of the chamber and is directed toward a first heat exchanger of the refrigerant loop; and
wherein adjusting the first set of ventilation doors and the second set of ventilation doors causes the HVAC system to operate in a second operational mode distinct from the first operational mode.

16. The non-transitory, computer-readable storage medium of claim 15, wherein:
adjusting the first set of ventilation doors includes controlling the first set of ventilation doors such that the first amount of return air entering the system via the first portion of the chamber is a non-zero amount and the first amount of outdoor air entering the system via the first portion of the chamber is substantially zero; and
adjusting the second set of ventilation doors includes controlling the second set of ventilation doors such that the second amount of return air entering the system via the second portion of the chamber is substantially zero and the second amount of outdoor air entering the system via the second portion of the chamber is a non-zero amount.

17. The non-transitory, computer-readable storage medium of claim 16, wherein
adjusting the first set of ventilation doors includes controlling the first set of ventilation doors such that a portion of the first amount of return air entering the system is directed to a second air-mover; and
adjusting the second set of ventilation doors includes controlling second set of ventilation doors such that a portion of the second amount of outdoor air is directed to a first air-mover.

18. The non-transitory, computer-readable storage medium of claim 15, wherein:
adjusting the first set of ventilation doors includes controlling the first set of ventilation doors such that the first amount of return air entering the system via the first portion of the chamber is substantially zero and the first amount of outdoor air entering the system via the first portion of the chamber is a non-zero amount; and
adjusting the second set of ventilation doors includes controlling the second set of ventilation doors such that the second amount of return air entering the system via the second portion of the chamber is a non-zero amount and the second amount of outdoor air entering the system via the second portion of the chamber is substantially zero.

19. The non-transitory, computer-readable storage medium of claim 18, wherein:
adjusting the first set of ventilation doors includes controlling the first set of ventilation doors such that a portion of the first amount of outside air entering the system is directed to a first air-mover; and
adjusting the second set of ventilation doors includes controlling the second set of ventilation doors such that a portion of the second amount of return air is directed to a second air-mover.

20. The non-transitory, computer-readable storage medium of claim 15, wherein:
adjusting the first set of ventilation doors includes controlling the first set of ventilation doors such that the first amount of return air entering the system via the first portion of the chamber is a non-zero amount and the first amount of outdoor air entering the system via the first portion of the chamber is substantially zero; and
adjusting the second set of ventilation doors includes controlling the second set of ventilation doors such that the second amount of return air entering the system via the second portion of the chamber is a non-zero amount and the second amount of outdoor air entering the system via the second portion of the chamber is substantially zero.
